(19) United States
(12) Patent Application Publication
(10) Pub. No.: US 2026/0235103 A1
(43) Pub. Date: Aug. 13, 2026

(54) POWER PLANT WITH VERTICAL AXIS WIND TURBINES

(71) Applicant: ENERGYPIER AG, Steinhausen (CH)

(72) Inventor: Laurent JOSPIN, La Chaux-de-Fonds (CH)

(73) Assignee: ENERGYPIER AG, Steinhausen (CH)

(21) Appl. No.: 19/161,248

(22) PCT Filed: Feb. 29, 2024
(86) PCT No.: PCT/IB2024/051945

§ 371 Date: Aug. 30, 2025

(30) Foreign Application Priority Data
Mar. 3, 2023 (CH) CH000231/2023

(51) Int. Cl. F03D 3/00; F03D 3/04; F03D 9/00; F03D 9/11; F03D 13/20; H02K 7/18; H02S 10/12; H02S 10/20; H02S 20/21

(52) U.S. Cl. CPC F03D 3/009; F03D 3/011; F03D 3/04; F03D 9/007; F03D 9/11; F03D 13/20; H02K 7/183; H02S 10/12; H02S 10/20; H02S 20/21; F05B 2240/212; F05B 2240/213

(57) ABSTRACT

The invention concerns a power plant with vertical axis wind turbines. Said vertical axis wind turbines (VAWT) comprise a rotor with rotating blades, mounted on a main shaft (14), said main shaft defining a lower end (14a) and an upper end, the lower end (14a) of the main shaft (14) being attached to a base structure (17), said base structure (17) being anchored through a foundation (124).

According to the invention, the power plant further comprises a civil engineering work (20) and a mechanical attachment (18) between the upper end of the main shaft and a portion of the civil engineering work.

### TECHNICAL DOMAIN

The present invention concerns the field of wind turbines or windmills, and more precisely the field of vertical axis wind turbines.

Small windmills or wind turbines, especially VAWT (vertical axis wind turbines) working with low wind speed near the ground have extremely frequently a profitability problem.

A Vertical Axis Wind Turbine (VAWT) of any significant size, whether used on land or substantially stationary barge or platform locations, typically needs bearings (rotative articulation) adjacent the top and bottom thereof in order to mount the substantially vertical shaft of the VAWT securely for proper rotation. Alternatively, such a Vertical Axis Wind Turbine (VAWT) requires one only but very strong and costly rotative articulation (of bearing type) near the ground, for attachment and mobility of the rotative vertical shaft of the VAWT.

The cost of the wind-turbine itself is not the main financial obstacle, which lies in the required resources for the concrete foundation which stabilizes the wind turbine in case of strong winds. Such concrete foundations require not only financial resources, but also a large quantity of material resource, in addition to technical and human resources.

### RELATED ART

There have been numerous different conceptions developed so far in relation with vertical axis wind turbines. Here are hereinbelow a few examples.

Document US2008095608 presents a VAWT wind engine including a support structure, an articulating rotor mounted on the support structure for rotation about a vertically extending axis, and at least one airfoil on the rotor for rotor-powering purposes. The articulating rotor is mounted in a manner enabling tilting movement of the rotor during rotation so that the airfoil produces rotor rotation and rotor tilt as the airfoil orbits the rotational axis. At least one mechanical linkage is included to actively vary airfoil pitch according to rotor tilt.

In document US2018149135 relates to a high efficiency vertical axis wind turbine (VAWT) comprising two counter-rotating rotors, each comprising a plurality of straight rotor blades. One rotor is placed on a first vertical axis and another rotor is placed on a second vertical axis. The first vertical axis and the second vertical axis are positioned on a support structure extending there between. The support structure, and the first vertical axis of rotation and second vertical axis of rotation, can rotate about an intermediate axis of rotation, which is placed at a midpoint between the first vertical axis of rotation and second vertical axis of rotation. An angled deflector is mounted to the frame at or about the intermediate axis of rotation. During operation, the vertex of the deflector is positioned toward oncoming wind. The deflector comprises two symmetrical deflecting surfaces that extend from the vertex to the rotors. One or more vortex generators are positioned on each deflecting surface.

In document WO2019129899, is presented a wind device with a body having a circular horizontal cross section that develops vertically, and at least two vertical axis wind turbines (VAWT) disposed and selectively movable along a side of the central body, rotating in the geometric centre of the cross section of the central body, the turbines being rotatably connected to shafts by structures, orienting the turbines in an optimal manner in the vicinity of the maximum cross section of the body, where wind flow is at maximum speed. Each structure supporting the upstream turbines supports respective fairings that conceal an area of the turbines that advances in the opposite direction with respect to the direction of the wind, and lateral plates that visually and acoustically conceal the turbines and able to accelerate the flow in said area of the turbines by means of the Venturi effect.

In document US2007212225A is presented a VAWTs cluster arrangement which notably enables reinforcement of the mechanical anchoring of the VAWT in the ground. This is accomplished by providing a plurality of VAWTs clustered together, with common and less expensive supporting structures. In another embodiment, a single VAWT is supported by a relatively light supporting structure, and an outrigger operatively connected to a stationary support.

Such last two solutions are not possible in all environments, notably when the space around the VAWT is restricted. Moreover, these supporting structure solutions still require important resources.

### Short Disclosure of the Invention

An aim of the present invention is the provision of a civil engineering work comprising at least one vertical axis wind turbine that overcomes the shortcomings and limitations of the state of the art.

Another aim of the invention is the provision of a civil engineering work comprising at least one vertical axis wind turbine where the foundation, namely the attachment of the wind turbine with the ground or any other base structure, is simplified in the sense of more lightweight without weakening the mechanical resistance of the vertical axis wind turbine.

Another aim of the invention is the provision of a civil engineering work where the attachment of the vertical axis wind turbine with the ground or any other base structure is not space demanding.

According to the invention, these aims are attained by the object of the attached claims, and especially by a power plant comprising at least one vertical axis wind turbine (VAWT), said wind turbine comprising a rotor with rotating blades, mounted on a main shaft, said main shaft defining a lower end and an upper end, the lower end of the main shaft being attached to a base structure, said base structure being anchored through a foundation, wherein it further comprises a civil engineering work and a mechanical attachment between the upper end of the main shaft and a portion of the civil engineering work.

With respect to what is known in the art, the invention provides the advantage that thanks to the support provided by the attachment of the upper end of the main shaft of the vertical axis wind turbine and a portion of the civil engineering work, the foundation anchoring the base structure of the wind turbine can be light-weighted.

Usually, such a foundation is a concrete foundation in the form of a big block or pad where the required volume of concrete in the ground is a huge investment in comparison to the vertical axis wind turbine, this big volume of concrete being necessary to get a sufficient mechanical resistance and stability of the wind turbine. Here, the invention provides a simple solution where the wind turbine is integrated into a system with a civil engineering work that constitutes a resistant structure, enabling fixing of the upper part of the wind turbine.

When said base structure of the vertical axis wind turbine is anchored in the ground through a concrete foundation, the provision of the invention allows a reduction of volume up to four of the required concrete with respect to normal concrete foundation, namely without attachment of the upper part (upper end) of the main shaft. This brings a strong reduction in the financial, material, technical and human resources needed for the installation of the wind turbine.

Conversely, if planned early enough, the strong concrete foundation of the Vertical Axis Wind Turbine (VAWT) enable to reduce the size and lighten the foundation of the civil engineering work comprising the Vertical Axis Wind Turbines (VAWTs).

The invention also brings a reduction in the strain withstood by the main shaft or support structure of the wind turbine due to both lower attachment and upper attachment of the main shaft. In this context, during operation of the wind turbine, when the strain or force applied on the lower attachment is divided by two (other half being applied on the upper attachment), the momentum is divided by four. Therefore, in addition to the reduction of size of the foundation for anchoring the base structure, there is a reduction of constraints applied to the main shaft of the wind turbine, which is beneficial in terms of maintenance, life duration and security.

Other advantages and possibilities will be presented in detail considering in the following text several embodiments of power plants according to the invention.

In possible embodiments, said vertical axis wind turbine is one of the following: a Darrieus wind turbine, a Savonius wind turbine, a combined Darrieus-Savonius wind turbine, a Giromill wind turbine or any other vertical axis wind turbine with a main shaft which extends or can be extended above the rotating portion(s) of the wind turbine for mechanical attachment of the upper end of the main shaft and a portion of a civil engineering work.

In possible embodiments of the power plant, said civil engineering work is one of the following: a building, a bridge, an artificial waterway or engineered channel, a dam, a railway installation, a road or a motorway facility

In possible embodiments of the power plant, said portion of the civil engineering work to which the upper end of the main shaft is attached, is any of the following: a covering, a column, a pillar, a pile, a pier, a slab, a girder, a beam, a raised structural part or overhanging structural part or overlooking structural part of the civil engineering work.

In possible embodiments of the power plant, it further comprises a set of photovoltaic panels. This provision brings another source of electricity to the power plant.

In possible embodiments of the power plant, the civil engineering work is a motorway facility, comprising a canopy covering a portion of motorway, said canopy being mounted over upright supports, wherein said photovoltaic panels are located on the upper face of said canopy. This allows the canopy to encompass another function, optimizing therefore its presence over the motorway.

As a complementary possibility, said vertical axis wind turbine(s) is (are) located under the canopy, on one side of the motorway, or on both sides of the motorway, the upper end of the main shaft of the vertical axis wind turbine being attached to the canopy. Such configuration allows, if applicable, the vertical axis wind turbine(s) to benefit of the wind acceleration that occurs on one side of the motorway, or on both sides of the motorway, due to the Venturi effect under the canopy.

### SHORT DESCRIPTION OF THE DRAWINGS

Exemplar embodiments of the invention are disclosed in the description and illustrated by the drawings in which:

FIG. 1 illustrates schematically, in a perspective view partially in section, a motorway covered with a canopy, forming a civil engineering work comprising at least one vertical axis wind turbine in a prior art arrangement, the overall forming a power plant;

FIG. 2 is a lateral view of the civil engineering work of FIG. 1, with a prior art arrangement of the vertical axis wind turbine on the left portion, and with an arrangement of the vertical axis wind turbine according to the invention on the right portion;

FIG. 3 is an enlarged view of the selected portion III of FIG. 2, showing more clearly the vertical axis wind turbine arranged according to the invention;

FIG. 4 is a perspective view of another implementation for a power plant with an arrangement of the vertical axis wind turbine according to the invention,

FIG. 5 is a perspective view of a possible implementation for the beams serving as upright supports in a civil engineering work forming as power plant according to the invention,

FIG. 6 is a side view of the civil engineering work of FIG. 4, in the direction VI of FIG. 4,

FIGS. 7 to 9 are simplified projection views from above of variants of the civil engineering work of FIG. 4, with a transparent canopy, considering different wind topologies; and

FIGS. 10a to 10c show possible different geometries of the section of deflectors used to re-orientate the location of the whirlwind created by the wind flow meeting the upright support of the canopy or the upright support of a cover or of any other portion of a civil engineering work.

### EXAMPLES OF EMBODIMENTS OF THE PRESENT INVENTION

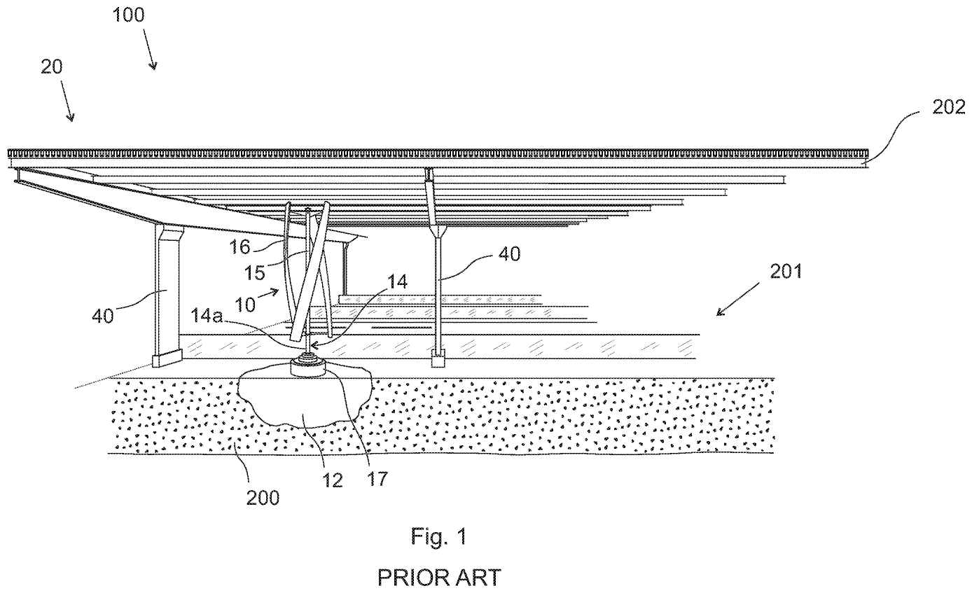

With reference to FIG. 1, is an example of a possible arrangement according to the prior art of a vertical axis wind turbine 10 in a civil engineering work 20. More precisely, in FIG. 1 is shown a motorway 201 covered with a canopy 202, forming a civil engineering work 20 comprising at least one vertical axis wind turbine 10. This canopy 202 is a mechanical structural portion located at the top of upright supports 40.

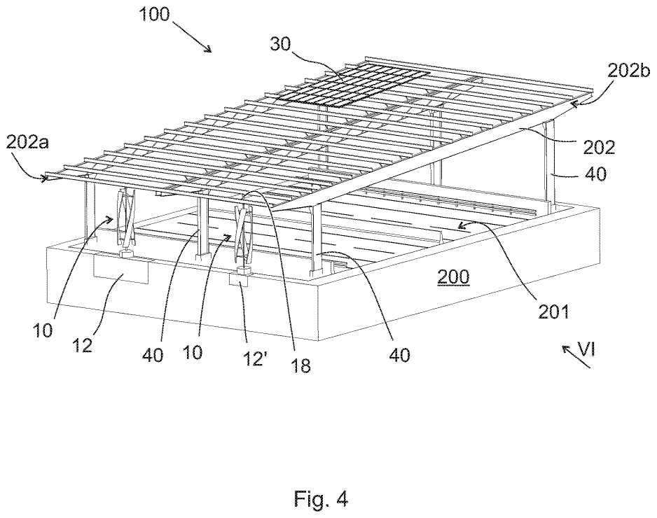

In some cases, such wind turbine is part of a civil engineering work, for instance an electrical power plant 100 combining production of electricity from wind by said vertical axis wind turbine 10 and production of electricity from another source, for instance solar cells mounted on photovoltaic panels 30 transforming solar radiations into electricity. Such an electrical power plant 100 is shown in FIG. 4.

Turning back to FIG. 1, the motorway 201 is covered by a canopy 202 forming a covering, which is a raised structural part mounted on upright supports 40.

Series of vertical axis wind turbines 10 are placed along the motorway 201, on one side or both sides of the motorway 201, thereby located below the canopy 202, notably below the edge of the canopy 202 as in FIG. 1. Each vertical axis wind turbine 10 is anchored in the ground by a foundation 12. The vertical main shaft 14 of the vertical axis wind turbine 10 bears or forms a rotor 15 comprising a plurality of rotor blades 16. In this configuration of the prior art, the lower end 14a of the main shaft 14 is attached to a base structure 17 anchored through a foundation 12. The base structure 17 contains some electrical equipment of the wind turbine 10, such as the generator. In this prior art configuration, the upper end 14b of the main shaft 14 is not attached. In this prior art configuration, the foundation 12 needs to form a very strong anchoring for the vertical axis wind turbine 10. In a most common situation, the vertical axis wind turbine 10 is not located in the vicinity of any other civil engineering work 20 or large structural part with available support for attaching the upper end 14b of the main shaft 14.

Usually, the foundation 12 is a concrete foundation forming a large size block of concrete in the ground 200.

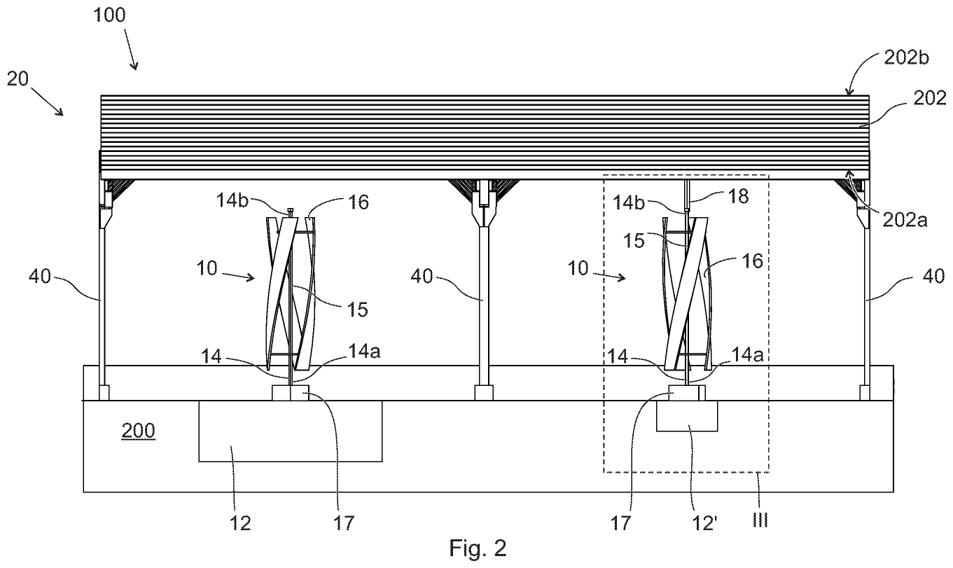

This prior art situation is also visible on the left part of FIG. 2 where the upper end 14b of the main shaft 14 is not attached.

According to the invention, as visible on the right part of FIG. 2, the upper end 14b of the main shaft 14 is attached. More precisely, the upper end 14b of the main shaft 14 is attached to a structural part of a civil engineering work. In the specific case of the example of the right part of FIG. 2, the upper end 14b of the main shaft 14 is fixed to the canopy 202 via an attachment device 18. On the right part of FIG. 2, the upper end 14b of the main shaft 14 of the vertical axis wind turbine 10 is attached to the first lateral side 202a of the canopy 202. This attachment device 18 provides a strong a secure fixing of the upper end 14b of the main shaft 14, which allow part of the strain suffered during operation of the vertical axis wind turbines 10 to be withstood by the upper end 14b of the main shaft 14 and attachment device 18. Consequently, the foundation 12′ of this arrangement according to the invention withstand less effort than the foundation 12 according to the prior art shown in the left part of FIG. 2. It is therefore possible to conceive and implement a foundation 12′ for the arrangement according to the invention which is smaller than the foundation 12 according to the prior art, as visible on FIG. 2.

Several configurations can arise in relation to the rotating part of the vertical axis wind turbines 10, among which the followings. In some types of vertical axis wind turbines 10, the main shaft 14 corresponds to the rotor 15 itself, the blades being fixedly mounted on the main shaft 14. In that case, said main shaft 14 is a rotating main shaft forming said rotor 15 on which the blades are mounted and said vertical axis wind turbine 10 further comprises a bearing or another rotating connection device (not shown), that supports and guides said rotating main shaft 14. Possibly, this bearing or another rotating connection device is placed in connection with both lower end 14a of the main shaft 14 and base structure 17, and also in connection with both upper end 14b of the main shaft 14 and the attachment device 18.

In other types of vertical axis wind turbines 10, the main shaft 14 is fixed (non-rotating) and linked to the rotor 15 on which the blades 16 are fixedly mounted. In such configuration, the rotor 15 is rotatably mounted with respect to the main shaft 14.

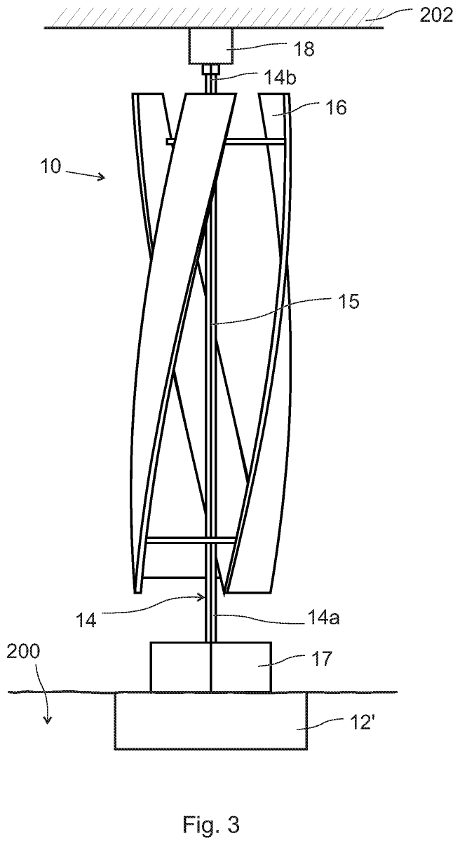

An enlarged view of the integration of a vertical axis wind turbine 10 into the civil engineering work according to the invention is visible in FIG. 3. The first and main difference with the prior art relates to the presence of an attachment device 18 connecting the the upper end 14b of the main shaft 14 of the vertical axis wind turbine 10 with the structural part of a civil engineering work (here a canopy 202 of a a motorway facility). The second difference lies in a foundation 12′ of the vertical axis wind turbine 10 which is smaller than the classical foundation 12 previously used, at least twice smaller and up to four times smaller. This reduced foundation 12′ is possible thanks to the attachment of the upper end 14b of the main shaft 14 of the vertical axis wind turbine 10 with the structural part.

In FIG. 4, is illustrated an example of a power plant 100 which corresponds to the right part of FIG. 2 with another source of electricity, in addition to the vertical axis wind turbines 10. This other source of electricity relies on photovoltaic panels 30. More precisely, in FIG. 4, the civil engineering work 20 is a motorway facility, comprising a canopy 202 covering a portion of motorway 201, said canopy 202 being mounted over upright supports 40. As in FIGS. 1 and 2, said canopy 202 is not only a protection for the portion of motorway 201 but also a deflector for accelerating the airflow below the canopy 202 thanks to the power plant's supporting structure. This accelerated airflow is converted with a higher ratio into electricity by the vertical axis wind turbines 10. In addition, in the power plant 100 shown in FIG. 4, the canopy 202 also allows for said photovoltaic panels 30 to be located on the upper face of said canopy 202.

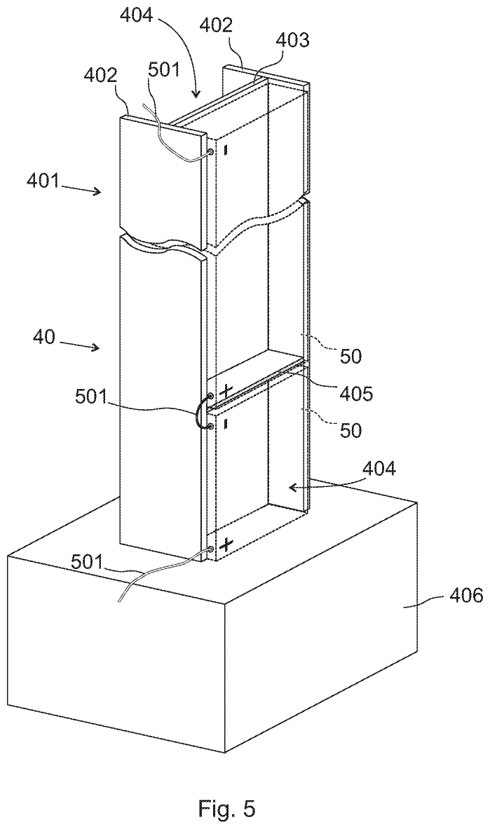

When said civil engineering work 20 comprises upright supports 40, another arrangement might be provided as follows. At least some of the upright supports 40 comprise beams 401 with a H shape section as visible on FIG. 5. The beams 401 consist in two flanges 402 connected by a web 403, both sides of the web 403 defining with said two flanges 402 a housing 404. The power plant 100 can further comprise electrical batteries 50 for storing electricity delivered by the vertical axis wind turbines 10, said batteries 50 being accommodated and stacked in said housing(s) 404 of the beams 401. Such a configuration has electrical cables 501 between both adjacent batteries 50, which are mounted in series, also between the batteries 50 and other electrical equipment, including the vertical axis wind turbines (VAWTs), possible other pieces of equipment such as, for instance, one or several of the followings: photovoltaic panels 30, generators, inverters, chargers, solar chargers (also called solar regulators), a distribution board, a remote management tool, a Wifi repeater. The batteries 50 can be used for others or additional electricity production system(s). In addition to or in place of vertical axis wind turbines (VAWTs) 10 and/or photovoltaic panels 30 as source of electricity, the batteries 50 can store electricity supplied by one or several electricity production system(s).

This configuration, with the presence of batteries 50 accommodated and stacked in housing(s) 404 of the beam(s) 401, can also can be implemented when the upright supports 40 comprise beams with an I shape section.

The presence of the batteries 50 in the upright supports 40 formed by beams 401 provides an additional weight and mechanical resistance to those upright supports 40.

In a possible implementation, said beams 401 are fixed in the ground by a foundation comprising at least three divergent foundation piles (not shown). This brings a strong and reliable anchoring which is also efficient against a pivoting strain applied on the beam 401.

In a possible arrangement, as visible in FIG. 5, said upright supports 40 further comprise horizontal spacers 405 in said housing 404, said spacers 405 being attached to said flanges 402 and forming shelves for the support of the batteries 50.

In a possible implementation, not visible on the figures, is also provided a cover on said upright supports 40, said cover forming a fairing able to deflect wind or any mass of moving air in direction of the rotating blades 16 of said vertical axis wind turbine(s) 10. This applies when the upright supports 40 define housing 404 able to accommodate electrical batteries or any other equipment needed by the civil engineering work, or not.

The electrical batteries 50 accommodated in the housing 404 are further able to store the electricity delivered by the photovoltaic panels 30.

The electrical batteries 50 can be any type of electrical batteries, preferably non-inflammable and non-exploding electrical batteries, for example molten salt batteries or solid-state batteries.

In addition to its function as a high-yielding electrical power plant 100, a structure as shown in FIG. 4 provides additional advantages to both motorway operators and users. The upper structure of the power plant 100, particularly its security barrier and canopy 202, acts as a sound insulator and ensures important noise reduction. The overhead canopy structure 202 protects the road surface of the motorway 201 from snowfall, thus eliminating or greatly reducing the need for winter maintenance such as salting and snow ploughing. The canopy 202 also protects from excessive heat and UV rays, thus considerably extending the service life of the road surface of the motorway 201. The canopy 202 can have a slanted overhead surface allowing for rainwater collection as visible on FIG. 4. The supporting structure (canopy 202 and upright supports 40) can be adapted to house cables and other conduits.

As can be seen in the embodiment shown in FIG. 4, the canopy 202 has a slanted overhead surface between the lateral sides 202a and 202b. The lateral sides 202a and 202b of the canopy 202 correspond to the sides of the canopy placed parallel to the traffic direction of the motorway 201. In this example, the canopy 202 has a plate shape. This inclined configuration of the top and bottom surfaces of the canopy 202 allows rainwater collection and evacuation but also brings a possible Venturi effect under the canopy 202. Depending on the local wind conditions, this lateral inclined orientation of the canopy 202, with a first lateral side 202a lower than the second lateral side 202b, creates a wind acceleration which raise the performance of the vertical axis wind turbines (VAWTs) 10. This wind acceleration is generally more important on the first lateral side 202a of the canopy 202 than on the second lateral side 202b of the canopy 202.

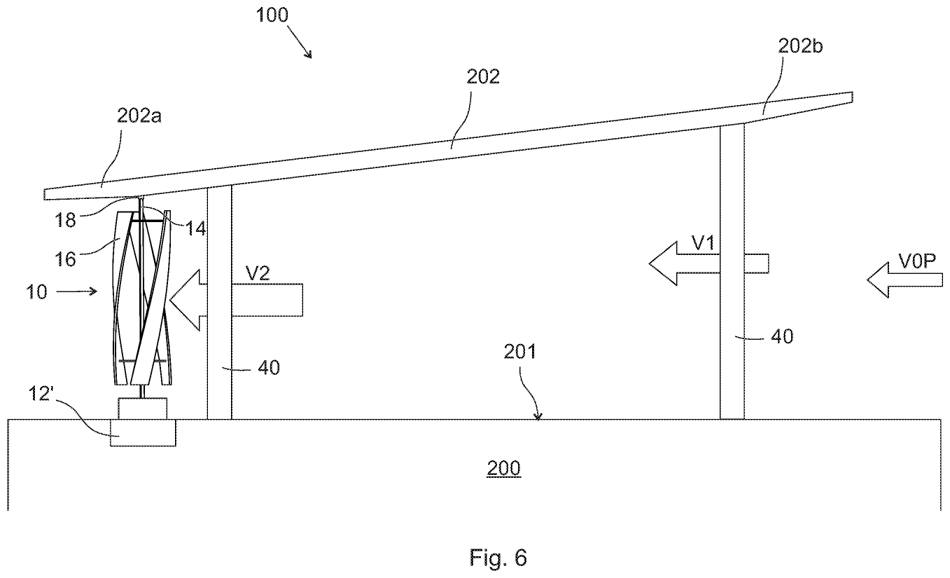

Referring to FIG. 6, the above-mentioned situation is illustrated for a natural wind which is stable or steady and orientated perpendicular to the direction of the motorway 201. This perpendicular natural wind is represented by arrow VOP on the right side of FIG. 6, at the location of the second lateral side 202b of the canopy 202, which is situated higher than the first lateral side 202a. When this wind flow of the perpendicular natural wind VOP enters the space below the canopy 202, under the second lateral side 202b, this becomes a directed perpendicular natural wind V1 passing around the line of upright supports 40 adjacent to the second lateral side 202b of the canopy 202. This directed perpendicular natural wind V1 has a higher speed than the perpendicular natural wind VOP due to the Venturi effect. While flowing under the canopy 202, the perpendicular natural wind accelerates further until it reaches the line of upright supports 40 adjacent to the first lateral side 202a of the canopy 202 on the left side of FIG. 6. At that point, the wind forms a directed and accelerated perpendicular natural wind V2 speeder than the directed perpendicular natural wind V1.

This means VOP<V1<V2. Such directed and accelerated perpendicular natural wind V2 allows a higher rotation speed for the vertical axis wind turbines 10 located under the first lateral side 202a of the canopy 202, with respect to the rotation speed that would have been generated by the perpendicular natural wind VOP.

This allows the vertical axis wind turbines 10 to enhance their performance even with low natural wind speeds. In other words, the presence of the canopy 202 (or any cover on the motorway 201), and in addition the inclined arrangement of this canopy 202 (or cover), boost low speed natural winds that would not be naturally profitable enough, resulting in an exploitable wind flow. This arrangement generates an accelerated natural wind which enables a speeder rotation of the vertical axis wind turbines 10 so that their energy efficiency becomes exploitable and valuable with low natural wind speeds. Alternatively, thanks to the acceleration of the natural wind created by this arrangement, bigger and more powerful vertical axis wind turbines 10 can be installed and rotate sufficiently rapidly to produce energy with a good yield.

To illustrate that energetic amplifying phenomenon, we can take the example of an inclined underside surface of the canopy 202 with a height of 12 meters at the second lateral side 202b of the canopy 202 (entrance of the flow of the perpendicular natural wind VOP) and a height of 8 meters at the location of the vertical axis wind turbines 10, close to the first lateral side 202a of the canopy 202. This configuration brings a wind acceleration along the canopy 202 of 150%, which allows a 3 m/s perpendicular natural wind (VOP) to be accelerated up to V2=4.5 m/s (Accelerated directed perpendicular natural wind) at the location of the vertical axis wind turbines (VAWTs) 10. Such a wind acceleration of about 150% between the perpendicular natural wind VOP at the entrance of the canopy and the accelerated perpendicular natural wind V2 along the first lateral side 202a of the canopy 202 where the vertical axis wind turbines 10 are located, makes an energetic leap from a non-exploitable situation into a situation of real value.

When the wind speed is multiplied by a X value between the perpendicular natural wind (VOP) and the accelerated perpendicular natural wind V2, the energetic gain can be multiplied at maximum by X3.

With a perpendicular natural wind of speed VOP=3 m/s, in the optimum conditions, this will be transformed by the arrangement considered above into an accelerated perpendicular natural wind with a speed V2=4.5 m/s.

First hypothesis: The vertical axis wind turbine (VAWT) 10 requires a more rapid wind speed than 3 m/s to produce energy in profitable condition. This means that 3 m/s is below the energetic low threshold from which the vertical axis wind turbine (VAWT) 10 starts to generate energy (electricity). Then, thanks to the arrangement considered above, and the generation of an accelerated perpendicular natural wind with a speed V2=4.5 m/s, the vertical axis wind turbine (VAWT) 10 will be able to deliver energy with a profitable energy yield, which corresponds to a positive energetic gap from a situation where there is almost no energy production to a situation where there is a valuable energetic production. This might correspond to an extreme situation where the energy production with a typical 10 kW (kilowatts) VAWT will be something between 0 and 100 W (Watts) with a wind speed=VOP to be compared with the energy gained with a wind speed=V2, which would be a power between 1 KW to 2 KW (kilowatt(s)). Second hypothesis: The energetic low threshold from which the vertical axis wind turbine (VAWT) 10 starts to generate energy (electricity) corresponds to a wind speed less than 3 m/s. Then, thanks to the arrangement considered above, and the generation of an accelerated perpendicular natural wind with a speed V2=4.5 m/s, the vertical axis wind turbine (VAWT) 10 will be able to delivers energy with a much more profitable energy yield. For instance, with a vertical axis wind turbine (VAWT) 10 delivering a very low energy yield with a natural wind speed of 3.0 m/s, for instance with an order of magnitude of one kilowatt-hour (1 kWh), with the arrangement described in the present text, the same vertical axis wind turbine (VAWT) 10 will benefit from an accelerated wind speed of 4.5 m/s, which corresponds to a maximum positive energetic gap of (1.5)³=3.37, leading to an energetic production up to more than 3 kilowatts-hour (more precisely up to 3.37 kWh).

Therefore, the placement of a series of vertical axis wind turbines 10 under the first lateral side 202a of the canopy 202 is optimal for having the most efficient energy supply from the vertical axis wind turbines 10.

In some cases, including when the motorway 201 covered with the canopy 202 is located in a windy area, in addition to this presence of a first series of vertical axis wind turbines 10 under the first lateral side 202a of the canopy 202, there is further also a second series of vertical axis wind turbines 10 under the second lateral side 202a of the canopy 202 where there exists a small but already profitable wind speed acceleration (V1>VOP in FIG. 4).

Alternatively, there can be only a second series of vertical axis wind turbines 10 under the second lateral side 202a of the canopy 202 without any first series of vertical axis wind turbines 10 under the first lateral side 202a of the canopy 202.

These situations are not shown in the figures but can apply for all the embodiments and configurations described in the present tex.

Preferably, the inclination of the canopy 202 is between 5 and 15% with respect to a horizontal surface (i.e an angular range of 3 to 9 degrees with respect to a horizontal surface), preferably more than 6% (more than 3.5 degrees), preferably between 8 and 12% (angular range of 4.5 to 7 degrees). These possible inclination range values relate at least to the top surface of the canopy 202. These possible inclination range values can also relate to the bottom (low) surface of the canopy 202.

The configuration described above with a perpendicular natural wind VOP is an optimal configuration. In case the natural wind has a different orientation with respect to the inclined canopy 202, there exist provisions to keep an enhanced yield of the performance of the vertical axis wind turbines (VAWTs) 10, as explained below.

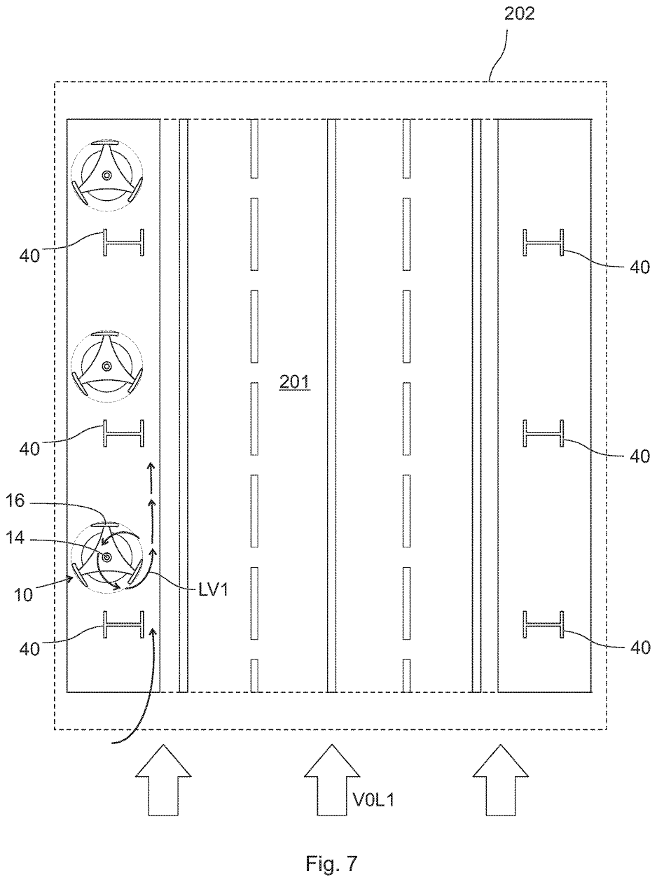

FIGS. 7 to 10 illustrate the situation where the natural wind is orientated parallel to the direction of the motorway 201. FIGS. 7 to 10 are simplified projection views from above of the civil engineering work of FIG. 4, with a transparent canopy 202. Such a longitudinal natural wind is represented by arrows VOL1, VOL2 and VOL3 in FIGS. 6 to 8.

Referring to FIG. 7, is considered the situation where the longitudinal natural wind is stable, represented by arrows VOL1 (stable longitudinal natural wind).

This stable longitudinal natural wind VOL1 flowing parallel to the motorway 20 and meets the pillars formed by the upright supports 40. This creates a whirlwind or local vortex LV1 behind each upright support 40.

This whirlwind or local vortex LV1 generated by the stable longitudinal natural wind VOL1 flowing towards and around the upright supports 40 is a stable local vortex LV1 illustrated by arrows turning around in a circle in FIG. 7. In order to take advantage of the accelerated flow of air of this stable local vortex LV1, the vertical axis wind turbines (VAWTs) 10 are located behind the support pillar with respect to the direction of the stable longitudinal natural wind VOL1. The location of the vertical axis wind turbines (VAWTs) 10 is established so that at least part of the rotor blades 16 meets the highest speed of the circulating flow of the stable local vortex LV1. Preferably no part of the blades 16 meets the axis of the stable local vortex LV1 where the air flow speed is null (zero) or close to zero.

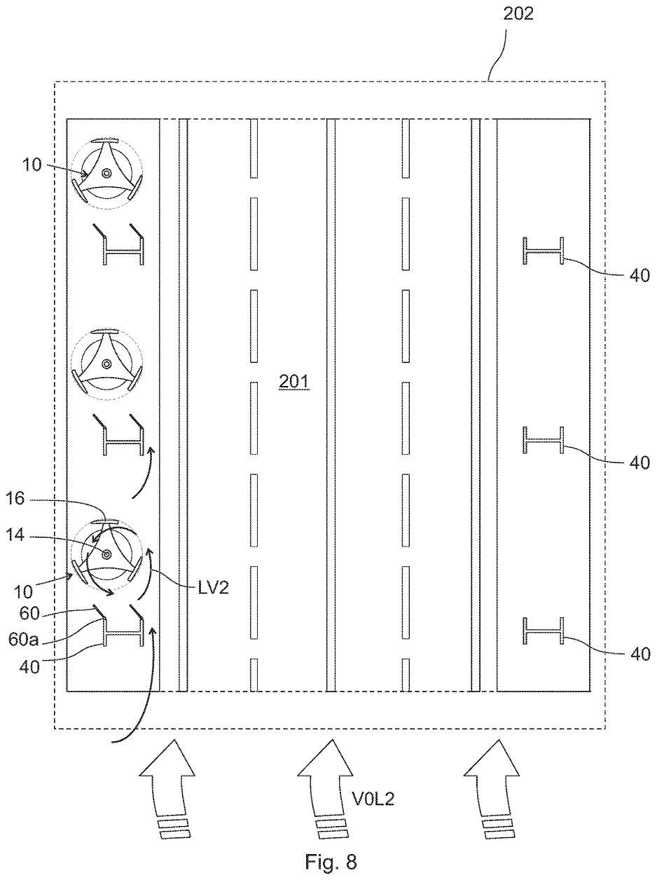

In FIG. 8, the illustrated situation concerns a longitudinal natural wind which is lightly unstable, represented by arrows VOL2 (lightly unstable longitudinal natural wind). This means the wind regime is moderately variable.

This unstable longitudinal natural wind VOL2 flowing more or less parallel to the motorway 20 and meets the pillars formed by the upright supports 40. This creates a whirlwind or local vortex LV2 behind each upright support 40. This whirlwind or local vortex LV2 generated by the unstable longitudinal natural wind VOL2 flowing towards and around the upright supports 40 is stabilized. In order to obtain such a stabilized local vortex LV2, deflectors 60 are attached to a free end of the flanges 402 of the beams forming the upright supports 40, or more generally to a free end of the upright supports 40. The deflector 60 is attached to the free end of the upright supports 40 which is not facing the flow of the unstable longitudinal natural wind VOL2 but which is opposite to the flow of the unstable longitudinal natural wind VOL2.

This stabilized local vortex LV2 is illustrated by arrows turning around in a circle in FIG. 8. In order to take advantage of the accelerated flow of air of this unstable local vortex LV2, the vertical axis wind turbines (VAWTs) 10 are located behind the support pillar 40 with respect to the direction of the unstable longitudinal natural wind VOL2, each of the deflector being located between a support pillar 40 and a vertical axis wind turbine (VAWT) 10. The location of the vertical axis wind turbines (VAWTs) 10 is established so that at least part of the rotor blades 16 meets the highest speed of the circulating flow of the stabilized local vortex LV2. Preferably no part of the blades 16 meets the axis of the stabilized local vortex LV2 where the air flow speed is null (zero) or close to zero.

In the illustrated embodiment of FIG. 8, there are two deflectors attached to the upright supports 40, but other possibilities are possible, among which one, three or more deflectors attached to the upright supports 40.

In the illustrated embodiment of FIG. 8, the two deflectors attached to the upright supports 40 are continuous part along most of or all the length of the upright supports 40, but other possibilities are possible, among which two, three or more portions of deflectors attached to the upright supports 40.

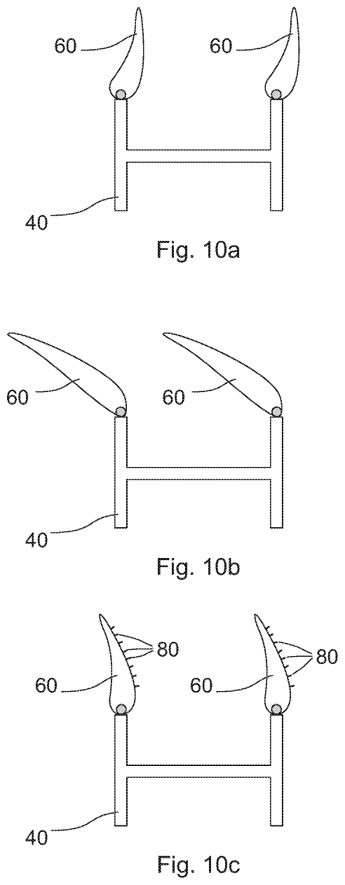

In a variant, the deflectors 60 are mobile with respect to the upright supports 40, thanks to an articulated connexion between each of the deflectors 60 and the upright supports 40 to which it is attached. In the illustrated arrangement of FIGS. 8 and 10, the deflectors 60 are mobile around a pivot axis 60a parallel to the upright supports 40. In that situation, there is a control unit and motorisation able to put the deflectors 60 in different orientations and to lock the orientation of the deflectors 60. Such a control of the orientation of the deflectors 60 enable an adaptation to the topology of the unstable longitudinal natural wind VOL2. This could be an adaptation in real time or in near-real time.

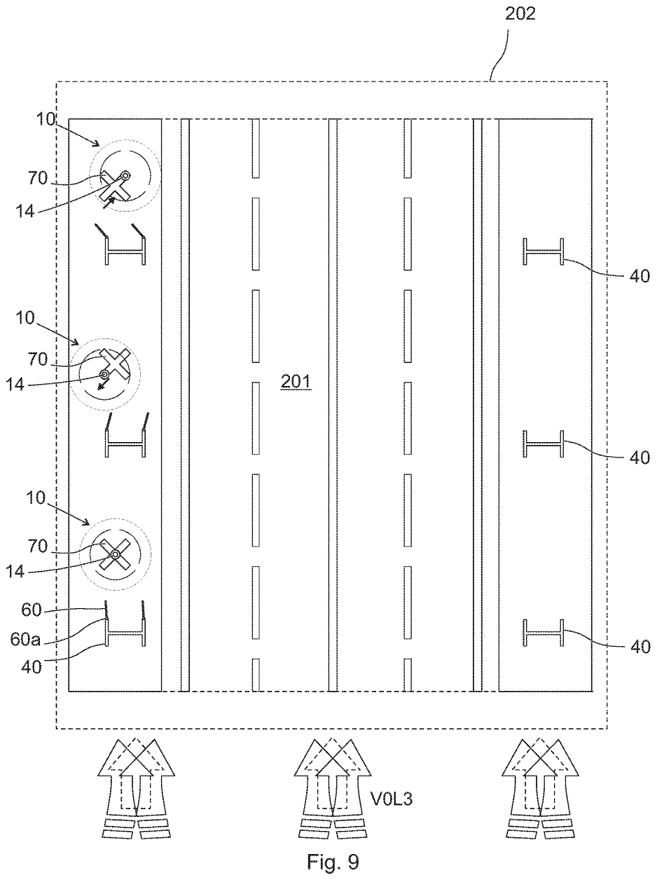

In FIG. 9, the illustrated situation concerns a longitudinal natural wind which is unstable, represented by arrows VOL3 (unstable longitudinal natural wind).

in that situation, all the details described above in relation with FIG. 9 and the stabilized local vortex LV2 are reproduced. In order to consider the variability of the wind regime, in addition to deflectors 60, this variant permits the change of location of the vertical axis wind turbines (VAWTs) 10. To that end, the main shaft 14 of the vertical axis wind turbines (VAWTs) 10 can be displaced in a limited extend to be located at the most efficient location considering the local and instantaneous wind morphology of the unstable longitudinal natural wind VOL3. In FIG. 9, rails 70 are installed at the base and at the top receiving arrangement (attachment device) of the main shaft 14 of each vertical axis wind turbine (VAWT) 10.

These rails 70 accommodate the lower end 14a and the upper end 14b of the main shaft 14. There is a pair of rails 70 for each vertical axis wind turbine (VAWT) 10. These rails 70 are shown in FIG. 9 with a cross shape. In this example, the four branches of the cross formed by these rails 70 being perpendicular by adjacent pairs, and forming a 45 or 135 degrees angle with the motor way direction. This arrangement enables to place the main shaft in the center of the cross formed by the rails 70 (see at the left bottom side of FIG. 9), or to place the main shaft in one of the branches of the cross formed by the rails 70 (see at the left middle and top side of FIG. 9).

Therefore, one set of rails 70 cooperate with the lower end 14a and with the upper end 14b of the main shaft 14, allowing to retain the lower end 14a and the upper end 14b of the main shaft 14 while enabling the change of location of the main shaft 14 with respect to the rails 70 or the blocking of the main shaft 14 with respect to the rails 70 in a determined location.

Those rails 70 can be replaced by grooves also cooperating with the lower end 14a and the upper end 14b of the main shaft 14, allowing to retain the lower end 14a and the upper end 14b of the main shaft 14 while enabling the change of location of the main shaft 14 with respect to the grooves or the blocking of the main shaft 14 with respect to the grooves in a determined location.

There can be a sliding connection between the rails or groove and on one hand the lower end 14a of the main shaft 14 and on the other hand with the upper end 14b of the main shaft 14.

In FIGS. 10a, 10b and 10c are shown different other profiles for the deflectors 60, in a non-limitative way. In FIGS. 8 and 9, the deflectors 60 have an elongated rectilinear section: this is a exemplary shape and this has to be adapted to perform the best stabilisation and/or orientation of the wind flow so that the vertical axis wind turbines (VAWTs) 10 receive the most adapted flow from the local vortex. In FIG. 10c, the deflectors 60 are equipped with vortex generators 80, formed by small flaps, for improving the effectiveness of deflectors 60.

In a possible arrangement, each vertical axis wind turbine 10 is located between two upright supports 40. In a possible arrangement, as visible in FIG. 4, each vertical axis wind turbine 10 is located between two upright supports 40, at equal distance from the two upright supports 40. In a possible arrangement, as visible in FIGS. 7 to 9, each vertical axis wind turbine 10 is located close to one of the two upright supports 40, for example less than 2 meters, or even less than 1 meter from the upright support 40.

All those described and exemplary situations present optimisation of the position of the vertical axis wind turbines (VAWTs) 10 with respect to the wind typology. This enables to get the most favourable energy efficiency and to capture the highest possible part of the wind energy by the vertical axis wind turbines (VAWTs) 10, providing thereby a enhanced yield of the power plant 100.

The position of the vertical axis wind turbines (VAWTs) will depend from numerous parameters among which on the orientation of the motorway, and the morphology of the natural wind on the site. The direction of this natural wind might not be perpendicular nor longitudinal as previously described in above examples, but might have another orientation comprising therefore a perpendicular component and a longitudinal component. The direction of this natural wind might change, also with a stable, lightly unstable or unstable nature of the wind.

### REFERENCE SIGNS USED IN THE FIGURES

VOP Perpendicular natural wind
V1 Directed perpendicular natural wind
V2 Accelerated directed perpendicular natural wind
VOL1 Stable longitudinal natural wind
VOL2 Lightly unstable longitudinal natural wind
VOL3 Unstable longitudinal natural wind
LV1 Stable local vortex
LV2 Stabilized local vortex
100 Power plant
200 Ground
10 Vertical axis wind turbine (VAWT)
12 Foundation of the prior art
12′ Foundation of the invention
14 Main shaft
14a Lower end of the main shaft
14b Upper end of the main shaft
15 Rotor
16 Rotor blade
17 Base structure
18 Attachment device
20 Civil engineering work
201 Motorway
202 Canopy
202a First lateral side
202b Second lateral side
30 Photovoltaic panels
40 Upright support
401 Beams of H or I shape
402 Flange part
403 Web part
404 Housing
405 Spacer (shelf)
406 Foundation
50 Battery
501 Electrical cable
60 Deflector
60a Articulation (pivot joint) between the de
70 Rails or grooves (cross shape)
80 Vortex generator

1. Power plant comprising:
at least one vertical axis wind turbine (VAWT), a base structure, and a foundation,
said wind turbine comprising a rotor with rotor blades mounted thereon, said rotor being mounted on a main shaft, said main shaft defining a lower end and an upper end, the lower end of the main shaft being attached to said base structure, said base structure being anchored through said foundation,
the power plant further comprising a civil engineering work and a mechanical attachment between the upper end of the main shaft and a portion of said civil engineering work.

2. Power plant according to claim 1, wherein said base structure of the vertical axis wind turbine is anchored in the ground through a concrete foundation.

3. Power plant according to claim 1, wherein said vertical axis wind turbine is one of the following: a Darrieus wind turbine, a Savonius wind turbine, a combined Darrieus-Savonius wind turbine, a Giromill wind turbine, and a vertical axis wind turbine with a main shaft which extends or can be extended above the rotating portion(s) of the wind turbine for mechanical attachment of the upper end of the main shaft and a portion of a civil engineering work.

4. Power plant (100) according to claim 1, wherein said main shaft is fixed (non-rotating) and linked to the rotor on which the blades are mounted.

5. Power plant according to claim 1, wherein said main shaft is a rotating main shaft forming said rotor on which the blades are mounted, wherein said vertical axis wind turbine further comprises a bearing that supports and guides said rotating main shaft.

6. Power plant according to claim 1, wherein said civil engineering work is one of the following: a building, a bridge, an artificial waterway or engineered shipping channel, a dam, a railway installation, and a road or a motorway facility.

7. Power plant according to claim 1, wherein said portion of the civil engineering work to which the upper end of the main shaft is attached is one of the following: a covering, a column, a pillar, a pile, a pier, a slab, a girder, a beam, and a raised structural part or a structural part of the civil engineering work.

8. Power plant according to claim 1, further comprising a set of photovoltaic panels.

9. Power plant according to claim 1, wherein said civil engineering work comprises upright supports.

10. Power plant according to claim 9, wherein said civil engineering work is a motorway, comprising a canopy covering a portion of motorway, said canopy being mounted over said upright supports.

11. Power plant according to claim 10, wherein said photovoltaic panels are located on an the upper face of said canopy.

12. Power plant according to claim 10, wherein said vertical axis wind turbine is located under the canopy, on at least one side of the motorway, the upper end of the main shaft of the vertical axis wind turbine being attached to the canopy.

13. Power plant according to claim 12, comprising a series of vertical axis wind turbines, wherein each vertical axis wind turbine is located between two upright supports.

14. Power plant according to claim 10, wherein said canopy has opposing top and bottom surfaces which have an inclined configuration, with a first lateral side lower than the second lateral side.

15. Power plant according to claim 14, wherein the inclination of the canopy is between 5 and 15% with respect to a horizontal axis.

16. Power plant according to claim 15, wherein the first lateral side and second lateral side of the canopy are placed parallel to the traffic direction of the motorway.

17. Power plant according to claim 9, wherein said at least some of the upright supports comprise beams with a H shape section or a I shape section, said beams consisting of two flanges connected by a web.

18. Power plant according to claim 17, wherein both sides of the web and said two flanges define a housing, wherein the power plant further comprises electrical batteries for storing electricity delivered by the vertical axis wind turbines, said batteries being accommodated and stacked in said housings of the beams.

19. Power plant according to claim 18, wherein said upright supports further comprise horizontal spacers in said housing, said spacers being attached to said flanges and forming shelves for the support of the batteries.

20. Power plant according to claim 18, wherein said electrical batteries are constructed and arranged to store the electricity delivered by the photovoltaic panels.

21. Power plant according to claim 18, wherein said electrical batteries are either molten salt batteries or solid-state batteries.

22. Power plant according to claim 18, wherein said beams are fixed in the ground by a foundation comprising at least three divergent foundation piles.

23. Power plant according to claim 9, further comprising a cover on said upright supports said cover forming a fairing constructed and arranged to deflect wind or any mass of moving air in direction of the rotating blades of said vertical axis wind turbine.

24. Power plant according to claim 10, further comprising deflectors (60) attached to the upright supports (40).

25. Power plant according to claim 24, wherein the orientation of each of said deflectors (60) can be changed by way of an articulated connection with the upright support to which the deflector is attached.

26. Power plant according to claim 25, wherein the orientation of the deflector is controlled by a control unit which is further able to lock the orientation of the deflectors.

27. Power plant according to claim 24, wherein at least some of said deflectors are equipped with vortex generators.

28. Power plant according to claim 24, further comprising rails or grooves cooperating with the lower end and with the upper end of the main shaft, allowing to retain the lower end and the upper end of the main shaft while enabling the change of location of the main shaft with respect to the rails or grooves and the blocking of the location of the main shaft with respect to the rails or grooves in a determined location.

29. Power plant according to claim 28, wherein said rails or grooves have a cross shape.

30. Power plant according to claim 14, further comprising a first series of vertical axis wind turbines (10) under the first lateral side of the canopy 202.

31. Power plant according to claim 14, further comprising a second series of vertical axis wind turbines under the second lateral side of the canopy.
